(19) United States
(12) Patent Application Publication
(10) Pub. No.: US 2013/0085939 A1
(43) Pub. Date: Apr. 4, 2013

(54) INTERACTIVE, AUTOMATED TRANSACTION REPORTING AND AUTOMATED COLLECTION

(71) Applicants: Ismail Kursat Colak, New York, NY (US); Jean-Marc Derek Freuler, New York, NY (US)

(72) Inventors: Ismail Kursat Colak, New York, NY (US); Jean-Marc Derek Freuler, New York, NY (US)

(21) Appl. No.: 13/249,647

(22) Filed: Sep. 30, 2011

(51) Int. Cl. G06Q 40/00

(52) U.S. Cl. 705/44; 705/39

(57) ABSTRACT

The present invention relates to reporting transactions, such as credit reporting, and provides systems and methods for conditioning payment from a purchaser to a seller of a scheduled payment based on the seller reporting information concerning the scheduled payment, or another scheduled payment to the seller, or a previous payment to the seller, or any combination thereof. The present invention also relates to systems and methods for automatically collecting payments from a purchaser for repayment.

### INCORPORATION BY REFERENCE

All documents cited or referenced in the appin cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates generally to reporting transactions, such as credit reporting, and, more particularly, to systems and methods for conditioning payment from a purchaser to a seller of a scheduled payment based on the seller reporting information concerning the scheduled payment, or another scheduled payment to the seller, or a previous payment to the seller, or any combination thereof. The present invention also relates to systems and methods for automatically collecting payments from a purchaser to repay, for example, credit extended by a seller in the event that a purchaser does not satisfy a payment obligation to the seller within an agreed term.

### BACKGROUND OF THE INVENTION

In existing reporting systems, such as credit reporting, particularly in trade credit, a seller reports the credit transaction details of a purchaser directly to a credit bureau or to a third party inquirer or a data receiver either based on agreements between the seller, the data receiver entity and the purchaser, or as a result of a unilateral consent from the seller to report data, for instance a payment performance data of a purchaser, to a third party entity.

With regards to a transaction handled on credit between a seller and a purchaser, existing systems require the seller to prepare, compile and transmit transaction data, such as payment performance data without any input from the purchaser. A seller is usually required to either transmit transaction data in writing, or over an electronic medium through a shared network and/or an application programming interface (API). Once the purchaser pays the seller or during a seller's reporting of delinquent, missing, defaulted or other non-performing payments, the purchaser is isolated from the reporting process, but can potentially engage in the information flow later through a dispute management system or through a payment performance reporting request submitted to the seller. Especially for sellers of smaller size, setting up and maintaining credit payment reporting channels and networks come with material time and labor costs.

Moreover, purchasers who would like to get their credit transactions reported or recorded for further reference do not currently have a method through which they can ensure reporting via their sellers. No existing system gives purchasers the capability to enforce sellers to report credit transaction information to credit bureaus or other third party inquirers. Especially for completed credit transactions that are paid early or on time, there is little incentive for a seller to report the payment performance to a third-party after the seller receives the due payment for that particular transaction from the purchaser.

Therefore, a substantial portion of payment experiences made by purchasers to the sellers is not captured by credit bureaus or third party inquirers. Most of existing sellers do not currently report payment performance information of their purchasers for credit transactions.

Citation or identification of any document in this application is not an admission that such document is available as prior art to the present invention.

### SUMMARY OF THE INVENTION

The present invention is an effective and efficient reporting system with conditional payment feature, through which purchasers can incentivize sellers to report their payment performances to third party data receivers such as credit bureaus.

The present invention relates to a system for conditioning a payment between a first entity and a second entity, wherein the system may comprise at least one computer, at least one storage device, and programming stored on a computer readable medium or media which causes the at least one computer to at least: receive notification of a scheduled payment from the first entity to the second entity; calculate payment performance data of the scheduled payment from the first entity to the second entity; notify the second entity of the scheduled payment from the first entity; transmit the payment performance data to a third-party data provider; and transmit a payment order to a financial institution associated with the first entity; wherein the transmission of the payment performance data to the third-party data provider and the transmission of payment orders to the financial institution associated with the first entity are conditioned on approval of the scheduled payment by the second entity.

The present invention relates to a method for conditioning a payment between a first entity and a second entity, wherein the method may be performed by a computer system which may comprise at least one computer, at least one storage device, and programming stored on a computer readable medium or media which causes the at least one computer to perform the method, wherein the method may comprise: receiving notification of a scheduled payment from the first entity to the second entity; calculating payment performance data of the scheduled payment from the first entity to the second entity; notifying the second entity of the scheduled payment from the first entity; transmitting the payment performance data to a third-party data provider; and transmitting a payment order to a financial institution associated with the first entity; wherein the transmission of the payment performance data to the third-party data provider and the transmission of payment orders to the financial institution associated with the first entity may be conditioned on approval of the scheduled payment by the second entity.

The present invention also relates to a method for conditioning a payment from a first entity to a second entity, wherein the method may be implemented by a computer system which may comprise at least one computer, at least one storage device, and programming that may be stored on at least one computer readable medium and that when executed causes the at least one computer to implement the method which may comprise: receiving information representing a scheduled payment from the first entity to the second entity; and authorizing a payment to the second entity according to the scheduled payment in the event that reporting information is received from said second entity.

The present invention also relates to a method providing for automatic collection from a first entity on behalf of a second entity, wherein the method may be implemented by a computer system which may comprise at least one computer, at least one storage device, and programming that may be stored on at least one computer readable medium and that when executed may cause the at least one computer to implement a method which may comprise: automatically collecting payments from the first entity to repay credit extended by the second entity according to a collection condition agreed upon by the first and second entities in the event that said first entity does not satisfy a payment obligation to the seller within a predetermined agreed term.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1A is a general illustration of credit payment performance reporting system between a purchaser and a seller.

FIG. 1B is an illustration of credit payment performance reporting system between a purchaser and a seller with system components.

FIG. 2 is a block diagram of a computerized method for identifying and registering the user on the platform.

FIG. 3 is a flow chart further illustrating the computerized registration process for platform user.

FIG. 4 is an overview of the automated searching and identification process for the seller entity.

FIG. 5 is a flow chart describing the computerized method for seller identity verification process on the platform.

FIG. 6 is an illustration of the automated computer system for scheduling and processing payments between purchaser and seller.

FIG. 7 is a schematic representation of the computerized system responsible for primary decisions regarding data inquiries and verifications.

FIG. 8 is a flow chart illustrating payment setup process for the purchaser.

FIG. 9 is an overview of the electronic review, modification and approval procedure of reporting data, as submitted by the seller.

FIG. 10 is an illustration of the computerized process for reporting late, defaulted, missing, non-performing or other incomplete payments.

FIG. 11 is an illustration of the computerized dispute recording and management mechanism for scheduled or completed transactions.

FIG. 12 is the illustrative registration process for an alternative representation of the automated payment scheduling and reporting system illustrated in FIG. 6.

FIG. 13 is an alternative representation of the automated payment scheduling and reporting system illustrated in FIG. 6.

### DETAILED DESCRIPTION OF THE INVENTION

Systems and methods described herein according to some embodiments of the present invention electronically identify and authenticate parties involved in a transaction, for instance a credit transaction, and allow a purchaser to set a reporting requirement for a seller as a condition for funds transfer to the seller.

As will be further understood from the ensuing description, according to some embodiments, the system in which a reporting requirement is set is a third-party (i.e., an entity independent of both purchaser and seller) credit reporting system that (i) triggers payment to the seller only if the seller fulfills the reporting requirement and (ii) reports to a data receiver (e.g., a credit bureau) payment performance information concerning the purchaser's payments to one or more sellers.

As will also be further understood from the ensuing description, conditioning payment on the seller fulfilling a reporting requirement ensures that the third-party reporting system will receive (or at least facilitates or enables the third-party reporting system to receive) sufficient information concerning the transaction between purchaser and seller for reporting information to the data receiver (e.g., sufficient information to confirm the terms agreed upon between purchaser and seller, and/or to satisfy the data receiver's content criteria, and/or to satisfy a reliability criteria, which may be established by the data receiver and/or the third-party reporting system). As further discussed below, the reporting requirement may comprise information concerning the terms of the transaction and, in some implementations, may alternatively or additionally include payment performance information (e.g., payment receipt date and payment amount, or receipt date of full payment).

As also further described below, some embodiments of the present invention, which may or may not include a conditional payment platform, comprise an automatic collection system and method that provides for, in the event that a purchaser does not satisfy a payment obligation to the seller within an agreed term, automatically debiting an agreed amount at a series of agreed times (e.g., agreed periodic intervals) from the purchaser's account to repay credit extended by the seller.

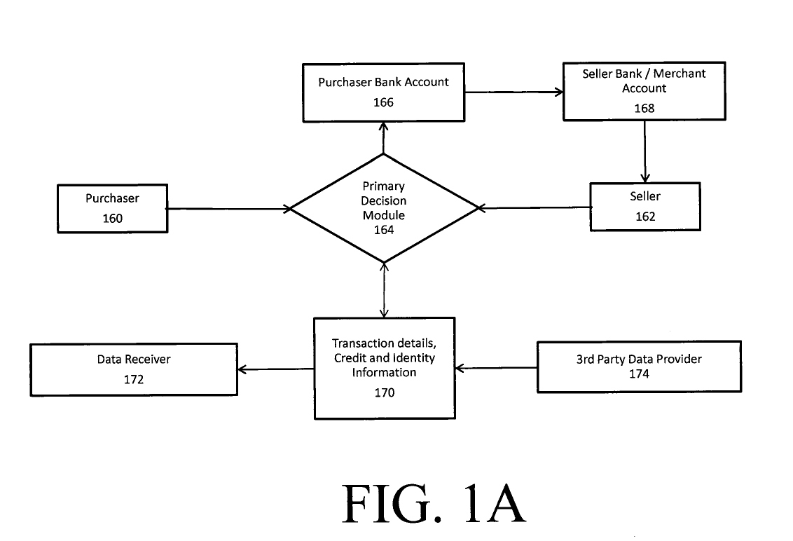

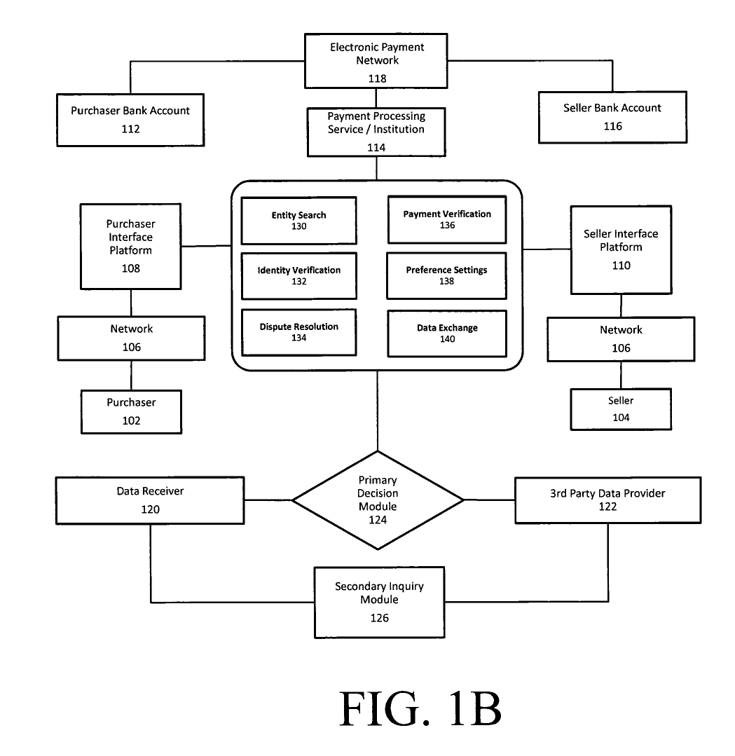

FIG. 1A is an overview of an illustrative credit payment performance reporting system between a purchaser 160 and a seller 162, where primary decision module 164 manages the funds flow about a transaction as well as the reporting requirement of the seller 162, in this example from the purchaser's bank account 166 to the seller's bank or merchant account 168 and while sharing transaction details, credit and identity information 170 with both a data receiver 172 and a third party data provider 174.

FIG. 1B is an illustration of credit payment performance reporting system between a purchaser 102 and a seller 104 with system components. A purchaser 102 can be a borrower, a debtor or a customer in a goods, services or credit transaction, which may include, for example, trade credit from suppliers. A seller 104 can be a lender, a creditor or a supplier or partner in a goods, services or credit transaction, which may include, for example trade credit to customers. In one embodiment, the purchaser and seller are connected through electronic platforms 108 and 110, respectively, whereby the purchaser can register a business or personal entity through an automated entity search system 130, locate and electronically verify the identity of its sellers through an identity verification system 132, schedule and make payments from purchaser's bank account 112 to the sellers bank account 116 through a payment verification system 136, a payment processing service 114 that is accessible through networks 106 and 118. The network may represent, or be part of, for example, the Internet, an intranet, a LAN (Local Area Network), WAN (Wide Area Network) or MAN (Metropolitan Area Network), a frame relay connection, Advanced Intelligent Network (AIN) connection, a synchronous optical network (SONET) connection, a digital T1, T3, or E1 line, Digital Data Service (DDS) connection, DSL (Digital Subscriber Line) connection, an Ethernet connection, ISDN (Integrated Services Digital Network) line, a dial-up port such as a V.90, V.34 or V.34bis analog modem connection, a cable modem, an ATM (Asynchronous Transfer Mode) connection, FDDI (Fiber Distributed Data Interface) or CDDI (Copper Distributed Data Interface) connections, WAP (Wireless Application Protocol), GPRS (General Packet Radio Service), GSM (Global System for Mobile Communication) or CDMA (Code Division Multiple Access) radio frequency links, RS-232 serial connections, IEEE-1394 (Firewire) connections, USB (Universal Serial Bus) connections or other wired or wireless, digital or analog interface or connections.

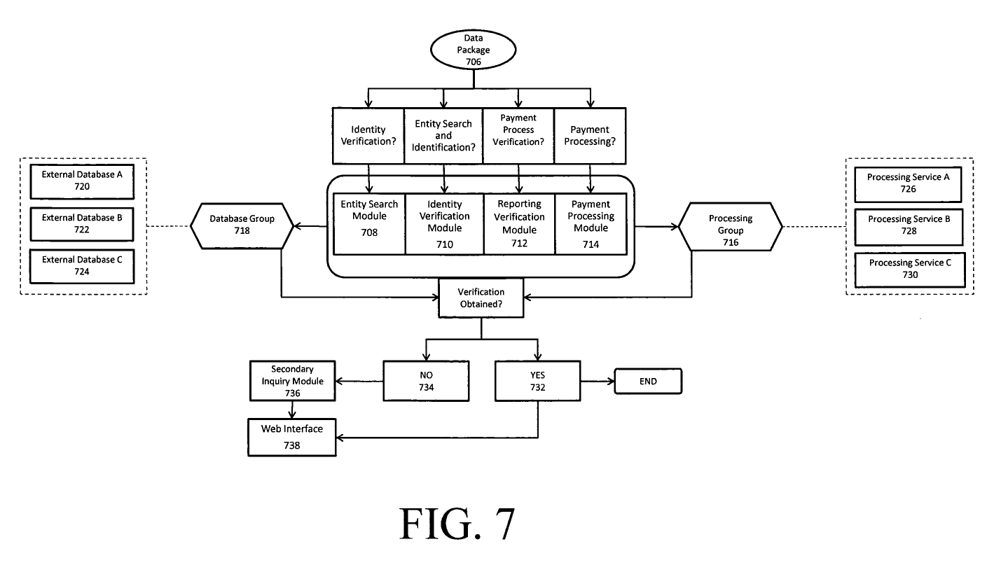

In this embodiment, the order of reporting & payment events are monitored and controlled by the primary decision module 124, that is connected to a third party data provider 122, for example a credit bureau, which acts as an information provider during identification, verification and reporting processes, further illustrated in FIG. 7. Through data exchange system 140, primary decision module 124 is also responsible for sending data collected through the interface platforms 108 and 110 to a data receiver 120, for example a credit bureau. In some cases, data receiver 120 may be the same entity as the third party data provider 122 and both may be structured as internal or external to the reporting platform. During any one of the processes where primary decision module cannot collect sufficient data from third party data provider 122 or data receiver 120, secondary inquiry module 126 prompts the purchaser 102 or the seller 104 to input additional data points in order to complete the process initiated by the primary decision module 124.

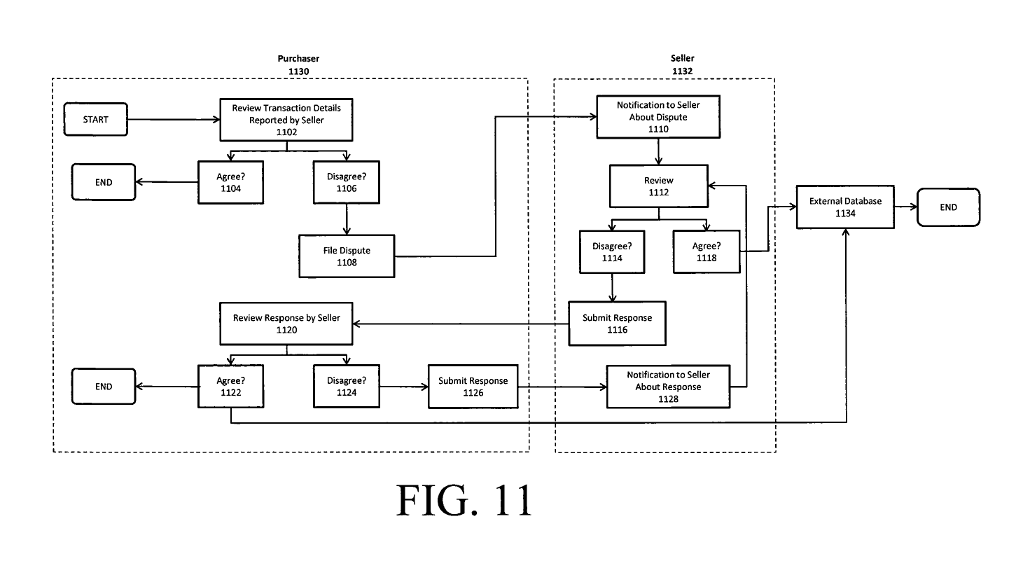

In some embodiments, the purchaser 102 or the seller 104 may view, modify or cancel their preferences 138 on platform functions, including the payment method, for example, ACH, check, electronic funds transfer or Paypal, payment or receiving account information, as well as communication options, reporting options, authorization and personal preferences. On another embodiment, the platform may also have built-in dispute resolution mechanism 134 for managing disputes regarding the transactions scheduled or executed on the platform, further illustrated in FIG. 11.

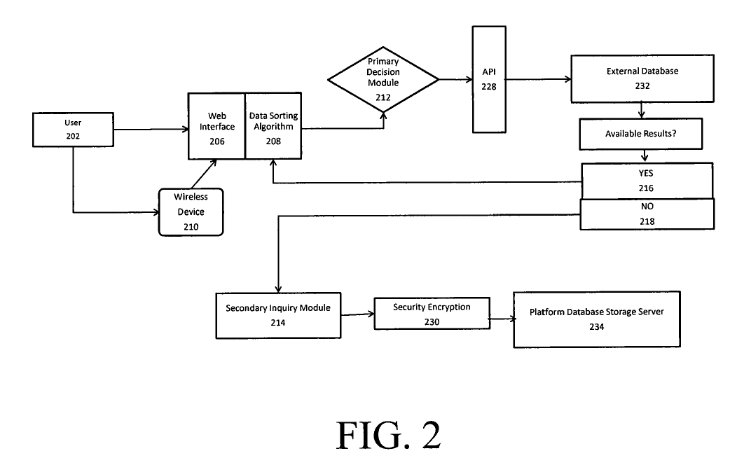

Entity search system 130 used in this embodiment is further illustrated in detail in FIG. 2, where a computerized method for identifying and registering the user on the platform is explained. The process is initiated by a user 202, who accesses the web interface 206 of the platform either through a wired connection or through a wireless connection device 210. In an example, a data sorting algorithm 208 then compares the results with existing data on the platform's database. This data can be stored either on an external server, over an online platform or within an internal database storage server. Data sorting algorithm 208 sends an inquiry to primary decision module 212 with a list of required data items to be obtained from an external database 232. In alternative embodiments, the database with information can be a continuous data pool without storage capacity, an internal server or a number of data sources that the primary decision module 212 connects, for example through an application programming interface (API) 228. This connection process to multiple databases or processing groups is further illustrated in FIG. 7. Any positive available results in state 216 received from the external database 232 are forwarded to the data sorting algorithm 208, which then stores and compares the newly available data to the list of required data elements. These data elements, for instance, can include business name, business address, telephone and fax details, business owner's personal details, business names and DBA (doing business as) titles, bank account access information, employer identification number, DUNS number, other credit bureau identification numbers, social security details, e-mail addresses, previously assigned identification numbers from third party sources and other online accounts the business owner or any of the entity's employees, consultants, advisors or affiliates might have.

In the current embodiment, any state 218 where one or more pieces of required data is not obtained from the user or the external database, automatically triggers a secondary inquiry module 214 that sets the protocol for identification and verification of the data elements not captured by the primary decision module 212 and through a security encryption 230 sends them to an encrypted platform database storage server 234 that keeps online platform data. In alternative embodiments, the secondary inquiry module 214 may prompt the user to input additional information and reconnect with primary decision module 212 to start another inquiry with either the external database 232 or the internal database storage server 234 using the additional data elements. Also, the security encryption 230 might be replaced by other security measures, or completely discarded. Likewise, alternative platform architectures may decide to keep the data at an external storage server or through an online network that does not require an offline server.

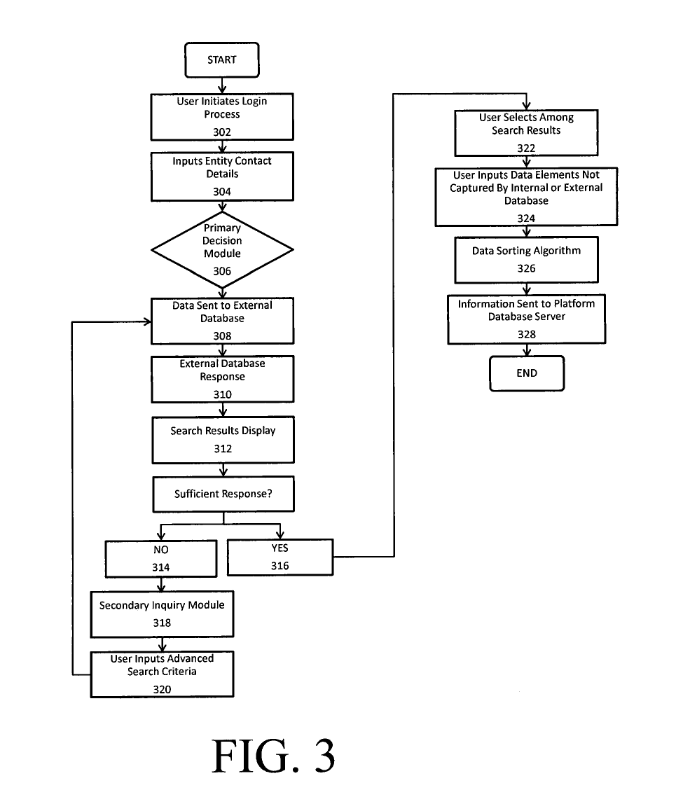

The computerized step by step registration process for platform user is further illustrated in FIG. 3 where the user initiates the login process at step 302 by either accessing the platform interface which may be assumed is present, or through a wired or wireless connection, with or without the assistance of another program, software or algorithm. The user then inputs entity contact details 304, which may include, for example, business name, business address, telephone and fax details and business owner's personal details. Input information is compared with existing records and available information by the primary decision module 306. Primary decision module 306 opens a new inquiry by sending the input data to an external database 308, in one embodiment for example, a credit bureau, either by sending the input information in part or in its entirety. External database responds at step 310 with available results 312. If the response is not sufficient as in step 314, the secondary inquiry module 318 prompts the user to input further information in order to better locate and identify the business or personal entity. In alternative embodiments, primary decision module 306 and secondary inquiry module 318 can be combined into a single unit. The user then inputs the advanced search criteria 320, which is then sent to the external database 308 for verification, identification or confirmation purposes. Alternatively, the user may not have to input advanced search criteria; instead, the secondary inquiry module 318 may connect to a third party to gather the information required in this process. If there is sufficient response displayed at step 316, the user is presented with the available options for the results. The results may either be business entities, such as company names, sometimes associated with addresses or phone numbers, or they may be direct business search responses received from credit bureaus. In alternative embodiments, the search results may refer to individuals rather than business entities. It is possible that the user is only presented with one result that the user has to confirm. After selecting the right entity among the search results at 322, the user is asked to input additional data elements not captured by either internal or external databases at 324, if required. Following the input, all gathered data elements are sent to the platform's own database server 328 through a data sorting algorithm 326 that, among other functionalities, for example, compares the new data with already existing data to prevent redundancies, or increases efficiency during data inquiries through data optimization techniques.

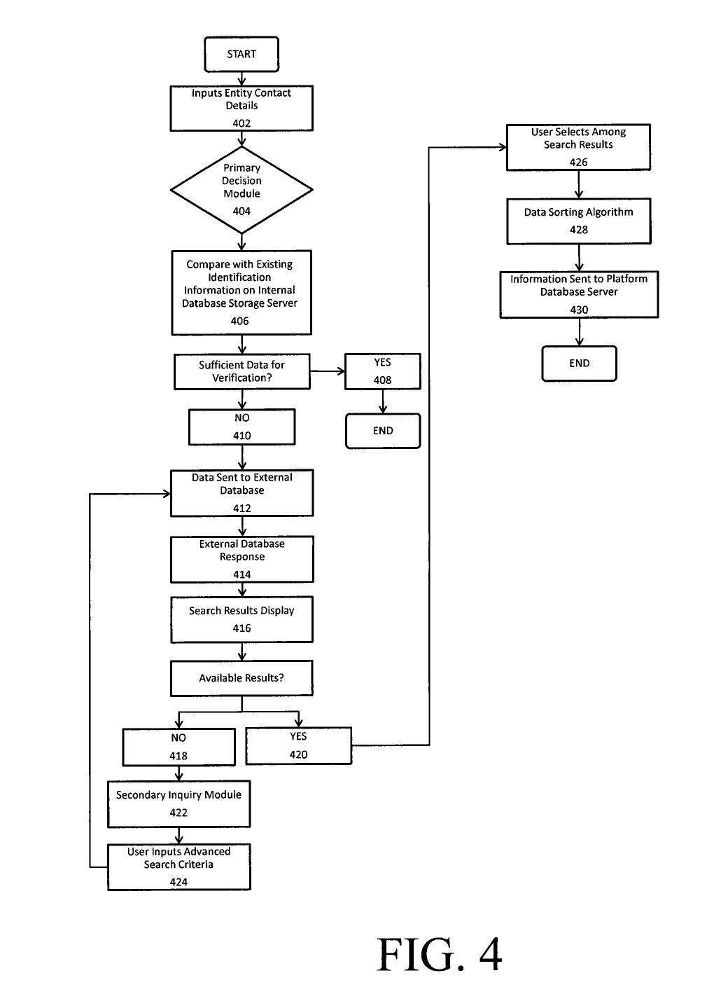

In this embodiment, the purchaser also has the capability to search and identify the seller from among a list, for example a credit bureau database, of business or personal entities. A further illustration is presented in FIG. 4, where there is an overview of the automated searching and identification process of the seller entity. The user inputs entity contact details at 402 and primary decision module 404 compares the existing identification information on internal database storage server at step 406 with the new data input by the user. The user may be the purchaser, an affiliate of the purchaser, a potential business partner, an employee of or an advisory with the purchaser entity, or a third party the purchaser has hired, contracted or simply asked to conduct the search on his behalf. In some cases, the user may be the seller. The contact details at 402 may include, for example, business name, address, e-mail address, telephone and fax numbers, third party identification codes such as federal employer tax ID, DUNS number, other credit bureau numbers or social security number. The database server at 406 may be internal, external, online, offline or another data storage device that does not require a server. If there is sufficient verification information to identify the seller at 408, identification process ends. However, in case of insufficient, inconsistent or inaccurate information at 410 where identification of the seller cannot be complete, the data is then sent to an external database 412, such as a credit bureau, a government agency or a private information agency. Once the external database response 414 is received and the results 416 are displayed, if there are available results to choose from at step 420, the user is prompted to select among the positive search results at 426. The selected search result is then stored in the platform database server 430 via a data sorting algorithm 428. If there are no available results to choose from at 418, secondary inquiry module 422 will prompt advanced search criteria 424 to the user for further identification attempts to inquire with database 412.

In alternative embodiments, the data sorting algorithm 428 and platform database server 430 may be combined in a single step. In other cases, the information may directly be saved into the database server without going through a data sorting algorithm, or not saved at all.

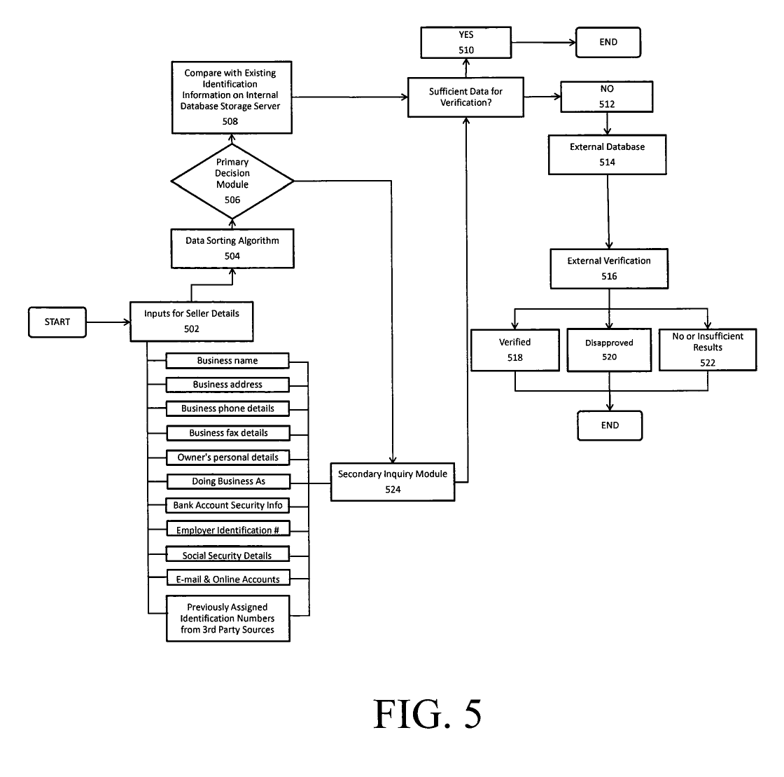

FIG. 5 is a flow chart describing the computerized method for seller identity verification process on the platform. Consequent to the seller identification process described in FIG. 4, FIG. 5 describes the system and method to verify that the seller that will in any way benefit from the platform's service is the same entity as recorded on the platform. The initial entity registration may be completed by the purchaser, the seller, or any affiliate, advisor, or employee of either party. In alternative embodiments, the verification process described by FIG. 5 can precede the identification process described in FIG. 4, or these two processes can be combined into a single process. In the embodiment illustrated by FIG. 5, the party initiating the verification process inputs information on the seller at 502, including details, for example, about the business name, address, phone number, fax details, DBA names, banks account information, third party identification numbers, titles or codes such as social security number, DUNS number or other credit bureau identification codes, e-mail or online account details. The party initiating the process may be the purchaser, the seller, an affiliated entity, an unaffiliated third party, or the platform itself. Data input is then transferred to the primary decision module 506 through a data sorting algorithm 504 that together compare the new input to existing data on the internal database storage server at 508. In cases where there are additional data requirements, primary decision module 506 may inquire, through secondary inquiry module 524 to receive additional inputs from the user. If primary decision module finds sufficient data to verify the identity, financial account information or business entity details of the seller in step 510, the process will be complete. Otherwise, step 512 will direct the primary decision module 506 to connect to an external database 514 for further verification attempts. Based on the external verification response 516 received from external database 514, the seller entity is either verified at 518, disapproved at 520 or the search did not result in sufficient data for verification or approval 522, depending on the depth of available information. Alternatively, insufficient results 522 may initiate another inquiry to obtain additional information through secondary inquiry module 524. Other embodiments may require fewer items for verification and can suffice with, for instance, an e-mail address and basic contact information, or an e-mail address and basic banking information including account and routing numbers, or with biometric identification methods. Alternative embodiments of seller verification may include, for example, criteria for minimum reporting requirements such as the number of years in operation, number of years in any external or internal database, minimum trade contacts, minimum duration of membership with any particular community, database, credit bureau, ratings or government agency or a financial institution, average sales, an average or minimum rating assigned for the entity by an external rating system. In alternative embodiments, the same verification process may also be used for the purchaser.

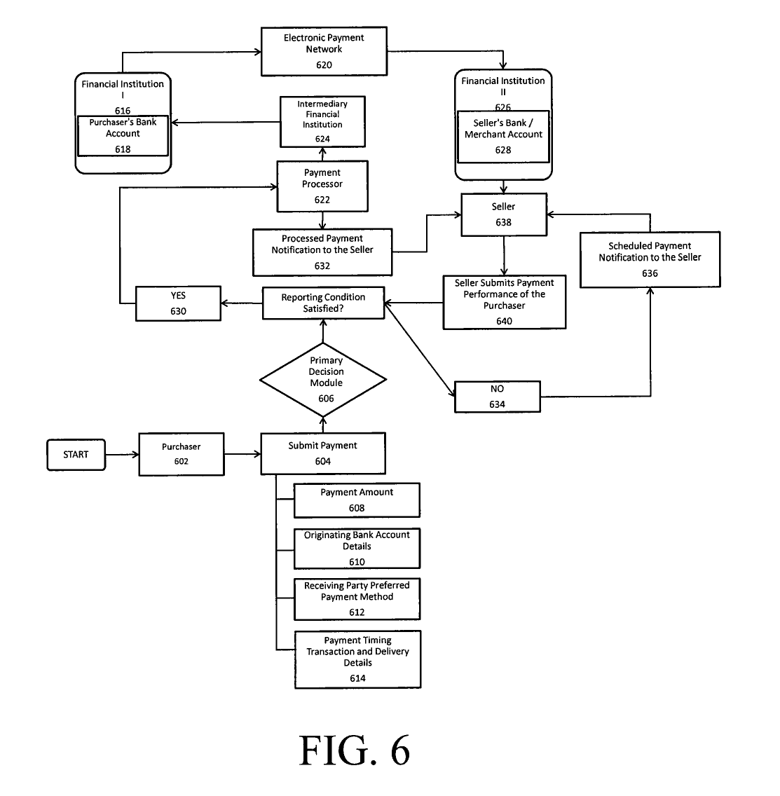

FIG. 6 is an illustration of the automated computer system for scheduling and processing payments between purchaser and seller. In this embodiment, a purchaser 602 is submitting a payment 604 to the seller 638 with associated data, including, for example, payment amount 608, originating bank account details 610, preferred payment method of the receiving party 612, payment timing, and transaction and delivery details 614 to the primary decision module 606. Separate from the payment order process, the seller 638 fulfills a reporting condition for the purchaser regarding the past or current transactions with the purchaser. In this embodiment, the seller reports the payment performance of the purchaser at step 640 on the platform, either through fax, mail, e-mail, telephone or through a network connection as illustrated in this embodiment. This reporting condition may be set either by the seller or the purchaser, and may for example be the payment performance data regarding any past or current credit transactions for goods or services, or loans provided from the seller to the purchaser. The reporting condition may, for example, refer to a payment performance reporting deadline for payments conducted in the past that includes supplier credit terms such as net 15, net 30, net 45, net 60 or net 90. In alternative embodiments, the purchaser may submit the reporting data and the seller may either manually or automatically modify, approve or reject the data. In other embodiments, an electronic platform may decide whether the reporting condition is satisfied without manual input from the seller 638 or the purchaser 602. In alternative embodiments, seller may pre-approve the payment performance at 640 before the purchaser submits payment at 604 or the funds may pass through a separate third-party account before going into seller's bank or merchant account 628.

The primary decision module 606 then checks to confirm that the reporting condition is satisfied. If, as in the case of step 630, the reporting condition by the seller 638 is satisfied, the payment order is sent to the payment processor 622. It is possible that the reporting condition may be satisfied with data obtained from a third party source other than the seller. In this embodiment, the payment processor 622 sends the payment order to an intermediary financial institution 624 which then transmits the payment for a funds transfer from the purchaser's bank account 618 in financial institution I 616 to the seller's bank or merchant account 628 in financial institution II 626 through an electronic payment network 620, which in alternative embodiments may be replaced by physical mail service. The bank or merchant accounts 618 and 628 may be a single account or multiple accounts, or they may be either at a single bank or more than one bank. The payment order may be in the form of a check, money order, domestic or international wire, any automated clearinghouse or Fed regulated payment order, physical or electronic check, Paypal or any other funds transfer method used by one or more of the parties involved in the transaction. Alternative embodiments, as in the example of Paypal payment technology, may not need one or more of the payment processor or the intermediary financial institution. Moreover, other embodiments may not need a payment processor 622 or an intermediary financial institution 624 to communicate with financial institution I 616 or financial institution II 626.

If the reporting condition is satisfied at 630, and payment is processed by the processor 622, a notification for processed payment 632 is sent over to the seller 638. In case 634 where reporting condition is not satisfied, a scheduled payment notification 636 is sent to the seller 638. The notifications 632 and 636 may be in any automated format, including for example voicemail, email, phone message, physical mail or an electronic notification method between a sender and a receiver.

If the reporting condition is not satisfied, as in step 634, a scheduled payment notification 636 is sent to the seller, notifying the seller 638 about some or all the details about the scheduled payment. In alternative embodiments, the notification for scheduled payment 636 may be replaced by processed payment notification 632 for a pre-determined or infinite period of time. In other embodiments, notifications 632 and 636 can be combined with or eliminated from the process. Alternative embodiments of the payment process described in FIG. 6 may also send the notifications 632 and 636 to the purchaser 602. Similarly, financial institution I 616, purchaser's bank account 618, financial institution II 626 and seller's bank/merchant account 628 may be replaced by the originating and receiving end components of a physical check, ATM, Paypal, or another funds transfer service.

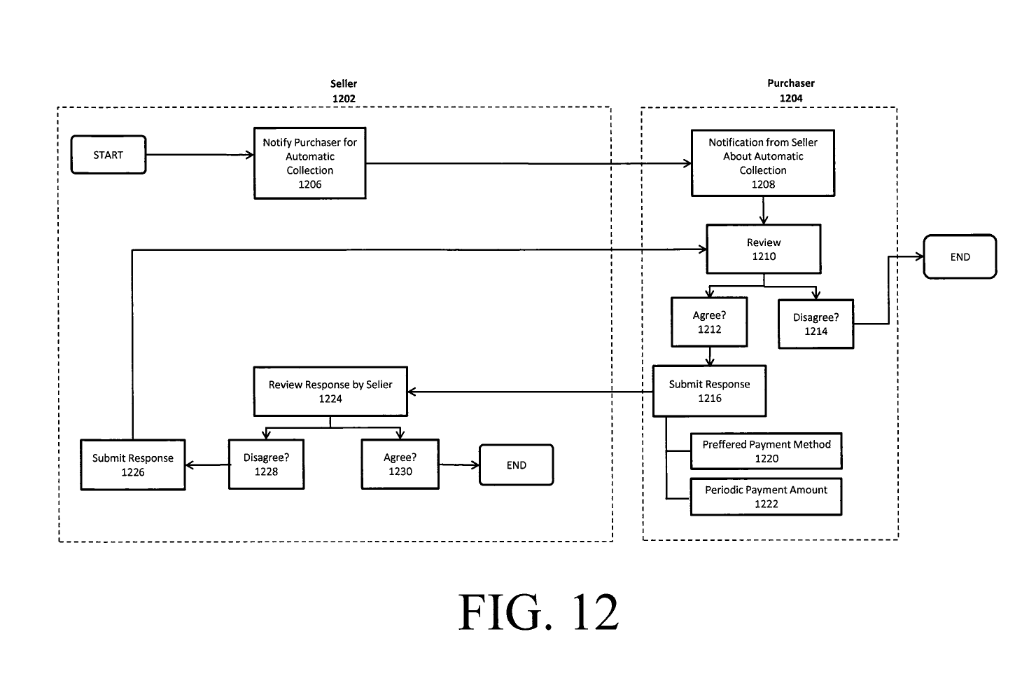

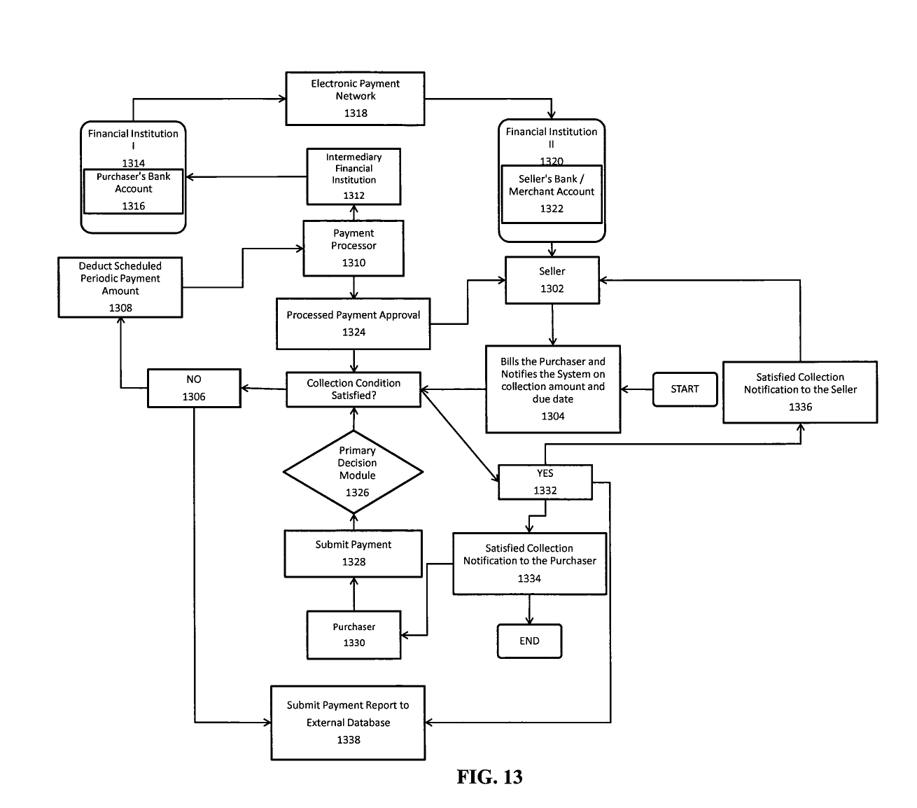

It is also possible to setup the payment processing and reporting structure, as illustrated by FIG. 13, for collection of outstanding receivables between purchaser 1330 and seller 1302. FIG. 12 is an illustration of the initial registration and setup process that takes place in this embodiment before the collection process for outstanding obligations. Outstanding obligations may be any payment due from the purchaser to the seller related to a goods, services or credit transaction between the purchaser 1204, the seller 1202 or any affiliates, representatives or agents of the purchaser 1204 or the seller 1202. In this embodiment, the seller 1202 notifies the purchaser 1204 for automatic collection at step 1206. Alternatively, the automatic collection mechanism process may be initiated by the purchaser 1204. Before or during this step, the seller 1202 may also include additional information with the notification, such as the preferred payment method, payment terms, conditions and account preferences. Purchaser 1204 then receives the notification from seller at 1208 and reviews the details at 1210. If the purchaser agrees to the automatic collection details at 1212, the purchaser 1204 submits a response 1216 back to the seller 1202 that includes details on the repayment, such as preferred payment method 1220 and periodic payment amount 1222. The seller 1202 then reviews the response at step 1224 and either agrees to the response at 1230 and completes the process or disagrees at step 1228 and submits a response 1226, which is sent to the purchaser 1204 for review at 1210. If the purchaser 1204 refuses to proceed with the process, the purchaser disagrees with the notification from the seller about automatic collection at 1214 and ends the process without setting up the system. In alternative embodiments, purchaser 1204 or seller 1202 may have more flexibility to change and modify respective settings on the automated payment system or the order of events to setup the automatic payment and reporting system.

FIG. 13 is an example embodiment illustrating how the automated payment and reporting system can be setup. The seller 1302 starts the process by billing the purchaser 1330 and notifying the system about the collection amount, as well as other details such as payment terms at 1304. The primary decision module 1326 acts as the central decision unit that monitors the total collection amount and actual amount repaid over the course of the entire process. In alternative embodiments, the due date for repayment may be immediate or may be, for example, in a number of days after a trigger event such as billing, delivery, invoicing or a set date by the seller 1302. Primary decision module 1326 keeps track of the outstanding collection amount. If the purchaser 1330 submits the full payment 1328 on or before due date, the collection condition becomes fully satisfied at 1332 and the process ends with payment notifications 1334 and 1336 sent to the purchaser 1330 and seller 1302. If, however, the collection condition is not satisfied on or before due date as in step 1306, the primary decision module 1326 sends a payment order to deduct the pre-agreed scheduled periodic payment amount 1308, through the payment processor 1310 and in this example with the solicitation of an intermediary financial institution 1312 by transferring funds from purchaser's bank account 1316 at financial institution I 1314 via an electronic payment network 1318 to the seller's bank or merchant account 1322 at financial institution II 1320. Step 1308 with the deduction, or automatic deposit amount, pre-agreed either by the purchaser 1330 or by both seller 1302 and purchaser 1330 is repeated over a period of time until the collection condition is fully satisfied by either a payment 1328 submitted by the purchaser 1330 or by a processed payment approval 1324 that is also communicated to the seller 1302 as well as the purchaser 1330. If the collection condition is not satisfied at 1306, the system may also notify an external database 1338, such as a credit bureau or a collections agency and transmits the collection performance in the particular transaction. The system may also act as a collection agency in itself in case of delinquent payments or defaults. Similar to FIG. 6, external database may also be notified in case of a satisfied collection condition 1332.

The periodic payment amount 1308 may be calculated by using different methods, and may, for example, be a fixed dollar amount or a percentage to be applied to the funds in the purchaser's Bank account 1316 that will be deducted periodically. The periodic deduction may occur, depending on preferences by the users or the decision module 1326, for example, on a daily, weekly, monthly, bimonthly, quarterly, or an annual basis, or might consist of a one-time deduction.

FIG. 7 is a schematic representation of the computerized primary decision module (referred as 124 in FIG. 1B) responsible for decisions regarding data inquiries and verifications with external parties. A data package 706 is sorted according to the nature of the decision process. In this embodiment, primary decision module may include, for example, an entity search module 708 responsible for decisions regarding the identification and searching process for the user, the seller or the purchaser, an identity verification module 710 responsible for verifying and matching user identities on the platform with seller and purchaser entities or their affiliates, employees, advisors or designated parties, a reporting verification module 712 responsible for decisions on the fulfillment of reporting condition according to FIG. 6 step 630 or 634, and a payment processing module 714 responsible for decisions on scheduling, confirming and processing payments, and verifying account identity, payment, bank and funds transfer information, and for decisions on the fulfillment of collection condition according to FIG. 13 step 1306 or 1332. In alternative embodiments, one of these modules may be responsible for a decision process that does not require exchanging information with an external party. In other embodiments, these functionalities may be outsourced, integrated with other functionalities, combined together or may not exist in the same level of detail.

Depending on the process type of the received data package, the modules 708, 710, 712 and 714 connect with the database group 718, which, for instance, includes external database A 720, database B 722 and database C 724. In one embodiment, for example, the databases may be credit bureaus, business or consumer information services, financial institutions, government or insurance agencies. The modules may also connect with a processing group 716 that may consist of different modules, such as those in this embodiment, processing service A 726, processing service B 728 and processing service C 730 for payment scheduling and processing related inquiries. The primary decision process is complete once the required verification on any one of the inquiries is obtained at step 732. If, however, required verification is not obtained, such as at step 734, the inquiry is transferred over through the secondary inquiry module 736 to the web interface 738 to prompt the user, which may be either the seller, the purchaser or a third party authorized to input the required information, to input additional data for further verification attempts. Other embodiments of the process may combine the primary decision module with the secondary decision module, or replace the web interface with a non-web based interface, an automated or electronic medium, a mobile device, or simple manual data population methods.

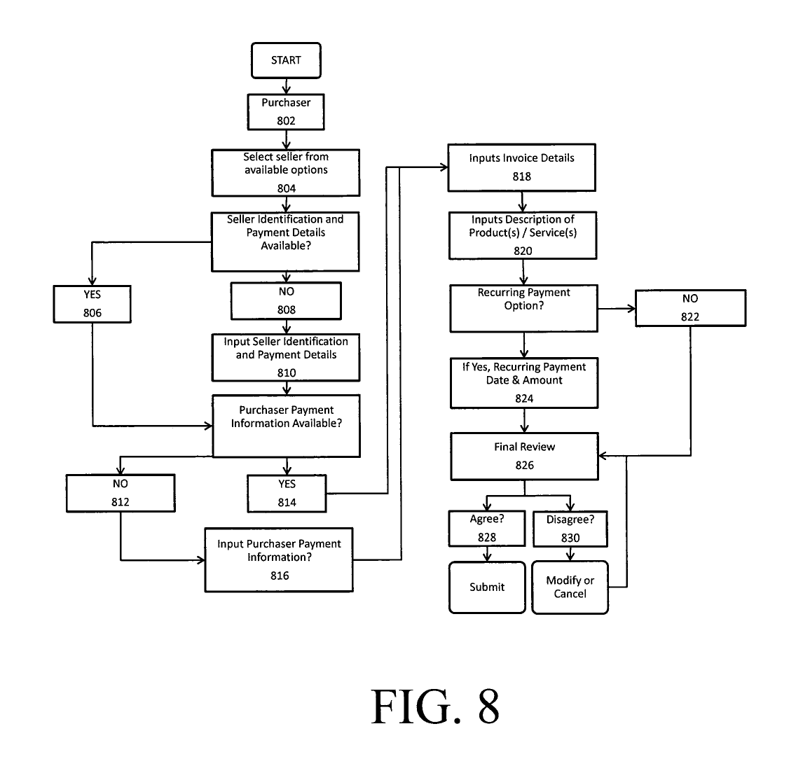

FIG. 8 is a flow chart illustrating payment setup process for the purchaser. In this embodiment, a purchaser 802 selects a seller from available options at 804. Displayed options may be a search result, a saved list of previous searches, a list of existing sellers on the purchaser's contact list or payment account or a new seller entry. If the seller identification and payment details are not available at 808, the user will input seller identification and payment details, for example, the name and address of the business, telephone, fax, email and third party identification details, bank, account, Paypal, point of sale (POS) or merchant account information details. If the seller identification and payment details are available at 806, then the system will automatically check to see if purchaser payment information is available at 814 or if the process needs additional input at 812. If not, the user will input seller identification and payment details 810, which include, for example, payment amount, payment account, invoice number, invoice date, payment terms, payment delivery method, service or product agreement associated with the transaction and payment date. Depending on data availability, the user will have to input purchaser payment information 816 or directly proceed to inputting invoice details 818. In alternative embodiments, the processing of data inputting may be automated, for example, may include electronic data uploads, or a form of application programming interface (API) communication or from a third party involved in the transaction such as a financial institution. The user is also prompted to input description of products and services 820 and set a recurring payment option with payment date and amount 824 if needed, or skip the step at 822. The user then reviews the scheduled payment at 826, if agrees with the information at step 828, submits the payment and if disagrees with the payment at step 830 either in part or in whole, modifies or cancels the payment. If the payment is modified, the system displays the final review 826 again for the user to agree or disagree with the modified payment information.

In alternative embodiments, the order of input processes may differ, for instance, the platform may process payment details before seller identification. Likewise, products and services description may be processed before payment information.

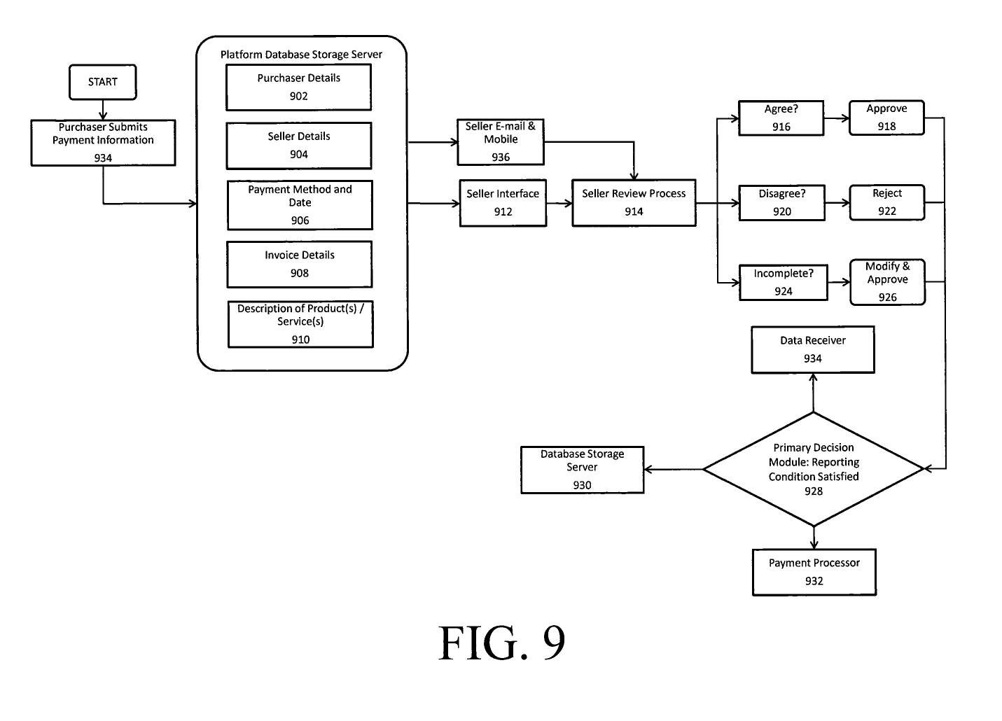

FIG. 9 is an overview of the electronic review, modification and approval procedure of reporting data, as submitted by the seller. In this embodiment, the purchaser submits payment information 934 and schedules a payment that includes information such as the purchaser identification details 902, seller identification details 904, payment method and date 906, invoice details 908 that may include payment amount, payment terms, delivery data and description of products and services 910 involved in the particular credit transaction. The payment information is then displayed or sent to the seller. In this embodiment, the seller can access the payment information either through a seller interface 912 such as an online platform web interface, an electronic connection between the platform and seller, seller affiliates or any third party that has an automated or electronic connection to the seller, or directly through an e-mail or mobile application 936, such as an online or desktop e-mail program, for example MS Outlook, Lotus Notes, Gmail, Hotmail, any other mail software or a mobile application for any desktop or mobile device, including, for example, Blackberry and iPhone mobile gadgets, widgets or applications that can transmit payment data between the seller or the purchaser with or without the help of an intermediary platform.

The seller then reviews the payment information at 914 and agrees at 916, disagrees at 920 or classifies the information as incorrect or incomplete at 924. Agreed information is approved at 918, disagreed information is rejected at 922 and the user is given access to the payment information to modify the payment details either in part, or as a whole at 926. Once the seller submits the payment information report, primary decision module at 928 considers the seller to have satisfied the reporting condition. If there is a scheduled payment pending satisfaction of the reporting condition, the primary decision module at 928 communicates with appropriate parties, for example in this embodiment with the payment processor 932, to process the payment. In alternative embodiments, the platform may be processing the payment using internal systems without communicating with another processor. The primary decision module also stores the information, in this embodiment at a database storage server 930 and sends the reported data to an external data receiver 934, for example a credit or a ratings bureau.

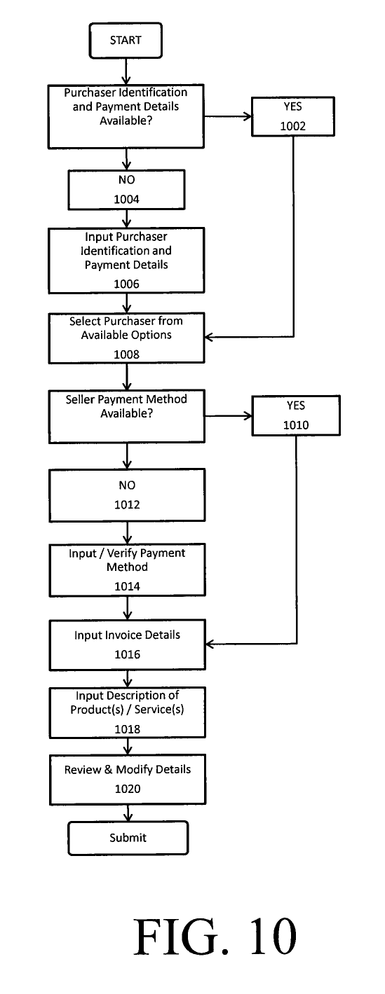

In alternative embodiments, the seller may submit the reporting information before the purchaser makes or schedules any payment. For example, FIG. 10 is an illustration of the computerized process for the seller to report credit transactions, including for example, late, defaulted, missing, non-performing or other incomplete payments owed by the purchaser. If the purchaser identification and payment details are available as in step 1002, the seller selects a purchaser from available search results at 1008; if the identification and payment details are not available, as in step 1004, the seller inputs purchaser identification and payment details 1006 before selecting a purchaser from available search results at 1008. If the seller payment method is already available at 1010, the seller proceeds to input invoice details. Otherwise, seller inputs unavailable payment method 1012 at step 1014 before invoice details. The user then inputs invoice details at 1016 and the description of products and services at 1018. The user then reviews and modifies the details at 1020 and completes the process. In alternative embodiments, any one of the steps that require input from the user may be automatically populated, either through information stored on an internal or external data source such as for example the user's accounting systems and software, or directly input by the purchaser rather than the seller.

In alternative embodiments, the order of steps 1006, 1008, 1012, 1014, 1016 and 1018 may vary. A version of the process described in FIG. 8 may be used by the seller to schedule expected payments as in the case of invoicing, essentially replacing the late payment reporting process described in FIG. 10.

Similarly, an alternative embodiment of the reporting process may allow the purchaser to make payments that conform to the payment terms submitted by the seller. Also in other embodiments, the entire payment scheduling and reporting process may take place through an email or a mobile application such as a mobile phone or blackberry device, without the need to register or access to a separate platform. Moreover, the payment scheduling and reporting process may be automated to require no input from the seller or the purchaser and may operate entirely on data obtained from seller's internal accounting systems or software, or from third party data providers. Also, the processes described in FIG. 9 and FIG. 10 can be integrated into another service such as electronic invoicing, billing, accounts receivable or an accounting software, application or program. FIG. 6 and FIG. 13 can be integrated into a bill-pay service, an accounts payable or receivable service, an accounting software, application or program. In either of these integration scenarios, all of the steps that require manual inputs can be eliminated or replaced by automated data feeds.

To manage disputes between purchaser and seller on the platform, FIG. 11 illustrates an example embodiment of the computerized dispute recording and management mechanism for scheduled or reported transactions. The purchaser 1130 reviews the transaction details 1102 reported by the seller 1132. Transaction details 1102 may also be collection information and preferences set by the users as described in FIG. 12 and FIG. 13. If purchaser 1130 agrees with reported transaction details at 1104, dispute process ends; if not, as in step 1106, the purchaser 1130 files a dispute 1108 that is then communicated to the seller as a dispute notification 1110. The dispute file 1108 may include disputes, changes or modification to any of the transaction details reported by the seller 1132, including, for example, payment amount, payment account, business entity, ownership, invoice detail, service product agreement related to the transaction, payment or delivery time. Following the review 1112 of the dispute, the seller 1132 may agree at step 1118 and end the dispute process. The modified transaction report is then sent to the external database 1134 and dispute management process ends. If the seller 1132 disagrees with the dispute at 1114, the seller 1132 can submit a response 1116 to be reviewed by the purchaser at 1120. The purchaser 1130 may agree to the response at 1122 and have the modified report be sent to the external database 1134 or disagree at 1124, in which case the purchaser 1130 can submit another response 1126 to the seller 1132. The seller is notified about the response at step 1128 which prompts the review process 1112 for the seller 1132.

Alternative embodiments to FIG. 11 may include one or more steps aimed at establishing direct connection between the purchaser and the seller for dispute resolution or a different dispute resolution process may replace the process described here in FIG. 11. In other embodiments, the dispute process may be outsourced or combined with that of a third party entity, such as a credit bureau.

According to some embodiments, as described hereinabove, based on a reporting condition being satisfied by a seller, a third party system selectively transmits a payment authorization message to another entity (e.g., a bank or a credit union) that, in response to such authorization, then causes payment to be made from a payor (e.g., the purchaser's account) to a payee (e.g., the seller's account, which may be at the same or another institution as the payor's account). In view of such described embodiments, those skilled in the art will understand, for example, that in various embodiments, the third party system may hold the payor's (e.g., purchaser) funds in escrow (e.g., an escrow account at a bank). Thus, in such embodiments, subject to the reporting condition being satisfied, payment would be transmitted from the escrow account to the payee's (e.g., seller's) account. Additionally, in various embodiments, rather than a third-party entity implementing the conditional payment mechanism, it may be implemented by a banking (or credit union) institution holding the payor's (e.g., purchaser's) account from which payment is made to the seller.

Also according to some embodiments, as described hereinabove, fulfillment of a reporting condition requires a seller to provide payment performance information comprising the date full payment was received from the purchaser. Those skilled in the art will understand, however, that in various embodiments the information required from the seller to fulfill the reporting condition may not include payment performance data (e.g., data representing payment receipt date and/or amount). For instance, in some such embodiments, the information required from the seller to fulfill the reporting condition may only comprise information that the system may use to confirm that the scheduled payment terms have been agreed upon. By way of example, the seller may input information affirming the terms of the scheduled payment previously submitted by the purchaser, or the seller may input information as to the seller's understanding of the terms and the system may compare (to confirm agreement) those terms with scheduled payment information previously or subsequently submitted by the purchaser. In such embodiments, for purposes of reporting to a data receiver (e.g., credit bureau) information representing the purchaser's payment performance, the system can rely on payment information received (e.g., by the payment processor) from one or more of the financial institutions operative in effecting payment.

It will also be understood in view of the foregoing that in various embodiments in which the seller provides payment performance information to the conditional payment system, the system may report to the data receiver based on the seller provided payment information and/or on the payment performance data that may be provided by one or more of the financial institution(s) involved in payment processing.

In various embodiments in which the seller is required to provide payment performance information to the reporting system, the seller may not be required to provide information to the reporting system that confirms (or allows the reporting system to confirm) the terms agreed upon with the purchaser. For example, in some embodiments, scheduled payment information provided to the reporting system (e.g., by the purchaser or another entity) may already represent a scheduled payment agreed upon by purchaser and seller. This agreement may be established, for example, through an electronic contracting (e.g., including negotiation functionality) system that is operated by another (trusted) entity. In such embodiments, payment may be conditioned on the seller providing payment performance information, and it is not necessary for the seller to provide information affirming the scheduled payment terms.

Some embodiments of the present invention can also be used in a process to intermediate credit deals between sellers, suppliers, individuals, or institutions in order to, for example, locate customer or supplier base for specific deals, offer targeted or generic credit deals or screen potential debtors or creditors. Credit can include, for example, trade credit by suppliers, loans, obligations, letters of credit, leases, or any financial product with a future repayment obligation. In credit deals, according to some implementations, some embodiments of the present invention may be combined with other third party databases providing further information on the individual user or business, which may include: the individual's payment performance on bills, rent or any other obligation, personal credit scoring models or financial information about the business.

Additionally, those skilled in the art will understand in view of the foregoing that various embodiments of the present invention may be implemented according to a variety of system configurations and/or messaging sequences. For instance, conditional payment methods and/or collection methods in accordance with the present invention may be implemented according to a variety of centralized or distributed system configurations and/or messaging sequences by using various software, hardware, and/or firmware components (e.g., including, in some implementations, trusted modules, such as trusted interface software modules) within the computer system(s) of any one or more of the purchaser, seller, payment processing entity(ies), data receiver, and/or third party data provider, to store, process, and/or communicate information in connection with executing conditional payment and/or collection in accordance with the present invention.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For instance, except to the extent necessary or inherent in the processes themselves, no particular order to steps or stages of methods or processes described in this disclosure, including the figures, is implied. In many cases the order of process steps may be varied, and various illustrative steps may be combined, altered, or omitted, without changing the purpose, effect or import of the methods described. Additionally, those skilled in the art will understand in view of the herein described embodiments that many other configurations exist for reporting and scheduling payments through electronic or online platforms and programs not specifically described herein but with which the present invention is applicable. Therefore, the present invention should not be seen as limited to the particular embodiments described above, but rather, should be considered to have wide applicability with respect to other transaction reporting, payment scheduling and execution systems and methods generally. Moreover, one skilled in the art will readily appreciate that certain features of each embodiment described herein can be used in combination with methods and systems illustrated or described in other embodiments. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

The invention is further described by the following numbered paragraphs:

1. A system for conditioning a payment between a first entity and a second entity, the system comprising at least one computer, at least one storage device, and programming stored on a computer readable medium or media which causes the at least one computer to at least:

receive notification of a scheduled payment from the first entity to the second entity;

calculate payment performance data of the scheduled payment from the first entity to the second entity;

notify the second entity of the scheduled payment from the first entity;

transmit the payment performance data to a third-party data provider; and

transmit a payment order to a financial institution associated with the first entity;

wherein the transmission of the payment performance data to the third-party data provider and the transmission of payment orders to the financial institution associated with the first entity are conditioned on approval of the scheduled payment by the second entity.

2. The system of paragraph 1, wherein the payment performance data comprise at least timeliness data of the scheduled payment from the first entity to the second entity.

3. The system of paragraph 1, wherein the third-party data provider is a credit reporting agency.

4. The system of paragraph 1, wherein the financial institution is a bank.

5. A method for conditioning a payment between a first entity and a second entity, the method being performed by a computer system comprising at least one computer, at least one storage device, and programming stored on a computer readable medium or media which causes the at least one computer to perform the method, the method comprising:

receiving notification of a scheduled payment from the first entity to the second entity;

calculating payment performance data of the scheduled payment from the first entity to the second entity;

notifying the second entity of the scheduled payment from the first entity;

transmitting the payment performance data to a third-party data provider; and

transmitting a payment order to a financial institution associated with the first entity;

wherein the transmission of the payment performance data to the third-party data provider and the transmission of payment orders to the financial institution associated with the first entity are conditioned on approval of the scheduled payment by the second entity.

6. The method of paragraph 5, wherein the payment performance data comprise at least timeliness data of the scheduled payment from the first entity to the second entity.

7. The method of paragraph 5, wherein the third-party data provider is a credit reporting agency.

8. The method of paragraph 5, wherein the financial institution is a bank.

9. A method for conditioning a payment from a first entity to a second entity, the method being implemented by a computer system comprising at least one computer, at least one storage device, and programming that is stored on at least one computer readable medium and that when executed causes the at least one computer to implement the method comprising:

receiving information representing a scheduled payment from the first entity to the second entity; and authorizing a payment to the second entity according to the scheduled payment in the event that reporting information is received from said second entity.

10. The method according to paragraph 9, wherein authorizing payment to the second entity is not executed unless the reporting information is received from said second entity.

11. The method according to paragraph 9 or 10, wherein the information identifying a scheduled payment is received from the first entity and represents the first entity's understanding of terms of the scheduled payment.

12. The method according to any one of paragraphs 9 through 11, wherein the reporting information received from said second entity comprises information indicative of the second entity's understanding of the scheduled payment.

13. The method according to any one of paragraphs 9 through 12, wherein the reporting information received from said second entity comprises payment performance information concerning at least one prior payment made by said first entity to said second entity in response to authorization by the system.

14. The method according to any one of paragraphs 9 through 12, wherein the reporting information received from said second entity comprises information concerning a previous payment to the seller.

15. The method according to any one of paragraphs 9 through 12, wherein the reporting information received from said second entity comprises information concerning another scheduled payment to the seller.

16. The method according to any one of paragraphs 9 through 12, wherein the payment from the first entity to the second entity according to the scheduled payment will not be authorized unless said reporting information includes information concerning all payments that the system authorized to be made to said seller within a prior predetermined time period.

17. The method according to paragraph 9, wherein the information identifying a scheduled payment includes data representing a scheduled payment amount and a scheduled payment due date.

18. The method according to any one of paragraphs 9 through 17, further comprising reporting to a third party data receiving entity information representing the first entity's payment performance.

19. The method according to paragraph 18, wherein the data receiving entity is a credit bureau.

20. The method according to paragraph 18 or 19, wherein the reporting to a third party data receiving entity is conditioned on the reporting information being received from the second entity.

21. The method according to any one of paragraphs 9 through 20, wherein said authorizing of the payment comprises communicating a payment order message to a third party financial institution associated with effecting payment transactions between the first entity and the second entity.

22. The method according to any one of paragraphs 9 through 21, further comprising receiving from a third party financial institution associated with effecting payment transactions between the first entity and the second entity payment confirmation information indicative of whether a payment to the seller was made based on a scheduled payment previously authorized by the system.

23. The method according to any one of paragraphs 9 through 22, wherein the reporting information comprises information indicating approval of the scheduled payment by the second entity.

24. A method providing for automatic collection from a first entity on behalf of a second entity, the method being implemented by a computer system comprising at least one computer, at least one storage device, and programming that is stored on at least one computer readable medium and that when executed causes the at least one computer to implement the method comprising:

automatically collecting payments from the first entity to repay credit extended by the second entity according to a collection condition agreed upon by the first and second entities in the event that said first entity does not satisfy a payment obligation to the seller within a predetermined agreed term.

25. The method according to paragraph 24, wherein automatically collecting payments from the first entity comprises invoking a series of debits from an account associated with said first entity, each debit being performed for an amount and at a time according to said collection condition.

26. The method according to paragraph 24 or 25, further comprising notifying or invoking a collection agency in the event that said collection condition is not satisfied.

27. The method according to any one of paragraphs 24 through 26, further comprising reporting to a third party data receiving entity information representing the first entity's payment performance in the event that the collection condition is satisfied and/or in the event that the collection condition is not satisfied.

28. The method according to paragraph 27, wherein the data receiving entity is a credit bureau.

29. The method according to any one of paragraphs 9 through 17, further comprising providing a third party entity information representing the first entity's payment performance.

30. The method according to paragraph 29, wherein the third party entity is not a credit bureau and neither shares nor sells credit data.

31. The method according to paragraph 29 or 30, wherein the information representing the first entity's payment performance is provided to said third party entity in response to a request from said third party entity.

32. The method according to any one of paragraphs 9 through 17, further comprising storing information representing payment performance of the first entity.

33. The method according to paragraph 32, further comprising performing a credit bureau function by providing at least a portion of the payment performance information concerning said first entity, and/or providing data generated or representing at least a portion of the payment performance information concerning said first entity, to another entity for the another entity's use in assessing first entity's creditworthiness.

34. The method according to paragraph 32, wherein the another entity is considering extending credit to the first entity.

35. The method according to paragraph 32, 33, or 34, wherein the payment performance information concerning said first entity, or a at least a portion thereof, and/or data generated or representing at least a portion of the payment performance information, represents a credit score for said first entity.

36. The method according to any one of paragraphs 29 through 31, wherein the operations of (i) receiving information representing a scheduled payment, (ii) authorizing a payment to the second entity, and (iii) providing a third party entity information representing the first entity's payment performance, are each carried out under the direction and control of a common entity or institution.

37. The method according to any one of paragraphs 29 through 31, wherein the operations of (i) receiving information representing a scheduled payment, (ii) authorizing a payment to the second entity, and (iii) providing a third party entity information representing the first entity's payment performance, are each carried out under the direction and control of affiliated entities or institutions.

38. The method according to any one of paragraphs 33 to 35, wherein the operations of (i) receiving information representing a scheduled payment, (ii) authorizing a payment to the second entity, (iii) storing information, and (iv) performing a credit bureau function by providing, are each carried out under the direction and control of a common entity or institution.

39. The method according to any one of paragraphs 33 to 35, wherein the operations of (i) receiving information representing a scheduled payment, (ii) authorizing a payment to the second entity, (iii) storing information, and (iv) performing a credit bureau function by providing, are each carried out under the direction and control of affiliated entities or institutions.

40. The method according to any one of paragraphs 9 through 17, further comprising sharing the payment performance data for credit scoring, credit approval, credit monitoring or credit reporting purposes with other entities who do not act in any of a repository, sharing or selling function of credit data.

41. The method according to paragraph 40, wherein the operations of (i) receiving information representing a scheduled payment, (ii) authorizing a payment to the second entity, and (iii) sharing the payment, are each carried out under the direction and control of a common entity or institution.

42. The method according to paragraph 40, wherein the operations of (i) receiving information representing a scheduled payment, (ii) authorizing a payment to the second entity, and (iii) sharing the payment, are each carried out under the direction and control of affiliated entities or institutions.

43. The method according to any one of paragraphs 9 through 17, wherein the method comprises:

receiving information representing scheduled payments for each of a plurality of purchaser entities to be made respectively to each of a plurality of seller entities;

for each of the scheduled payments, conditioning authorization of the scheduled payments to the seller entity according to the scheduled payment in the event that reporting information is received from the seller entity;

storing information representing payment performance for each of the purchaser entities; and

performing a credit bureau function by selectively providing at least a portion of the payment performance information concerning one or more of the purchaser entitites, and/or providing data generated or representing at least a portion of the payment performance information concerning one or more of the purchaser entities, to one or more other entities for the one or more other entities' use in assessing one or more of the purchaser entities' credit-worthiness.

44. The method according to paragraph 9, wherein authorizing payment in the event that reporting information is received from said second entity is carried out or initiated by invoking payment in the event that the reporting information is received from said second entity.

45. The method according to paragraph 9 or 44, wherein authorizing payment is carried out or initiated by generating and/or transmitting an authorization message.

46. The method according to paragraph 45, wherein the authorization message is a payment order message.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A system for conditioning a payment between a first entity and a second entity, the system comprising at least one computer, at least one storage device, and programming stored on a computer readable medium or media which causes the at least one computer to at least:
receive notification of a scheduled payment from the first entity to the second entity;
calculate payment performance data of the scheduled payment from the first entity to the second entity;
notify the second entity of the scheduled payment from the first entity;
transmit the payment performance data to a third-party data provider; and
transmit a payment order to a financial institution associated with the first entity;
wherein the transmission of the payment performance data to the third-party data provider and the transmission of payment orders to the financial institution associated with the first entity are conditioned on approval of the scheduled payment by the second entity.

2. The system of claim 1,
wherein the payment performance data comprise at least timeliness data of the scheduled payment from the first entity to the second entity or
wherein the third-party data provider is a credit reporting agency or
wherein the financial institution is a bank.

3. A method for conditioning a payment between a first entity and a second entity, the method being performed by a computer system comprising at least one computer, at least one storage device, and programming stored on a computer readable medium or media which causes the at least one computer to perform the method, the method comprising:
receiving notification of a scheduled payment from the first entity to the second entity;
calculating payment performance data of the scheduled payment from the first entity to the second entity;
notifying the second entity of the scheduled payment from the first entity;
transmitting the payment performance data to a third-party data provider; and
transmitting a payment order to a financial institution associated with the first entity;
wherein the transmission of the payment performance data to the third-party data provider and the transmission of payment orders to the financial institution associated with the first entity are conditioned on approval of the scheduled payment by the second entity.

4. The method of claim 3,
wherein the payment performance data comprise at least timeliness data of the scheduled payment from the first entity to the second entity or
wherein the third-party data provider is a credit reporting agency or
wherein the financial institution is a bank.

5. A method for conditioning a payment from a first entity to a second entity, the method being implemented by a computer system comprising at least one computer, at least one storage device, and programming that is stored on at least one computer readable medium and that when executed causes the at least one computer to implement the method comprising:
receiving information representing a scheduled payment from the first entity to the second entity; and authorizing a payment to the second entity according to the scheduled payment in the event that reporting information is received from said second entity.

6. The method according to claim 5,
wherein authorizing payment to the second entity is not executed unless the reporting information is received from said second entity or
wherein the information identifying a scheduled payment is received from the first entity and represents the first entity's understanding of terms of the scheduled payment or
wherein the reporting information received from said second entity comprises information indicative of the second entity's understanding of the scheduled payment or
wherein the reporting information received from said second entity comprises payment performance information concerning at least one prior payment made by said first entity to said second entity in response to authorization by the system or
wherein the reporting information received from said second entity comprises information concerning a previous payment to the seller or
wherein the reporting information received from said second entity comprises information concerning another scheduled payment to the seller or
wherein the payment from the first entity to the second entity according to the scheduled payment will not be authorized unless said reporting information includes information concerning all payments that the system authorized to be made to said seller within a prior predetermined time period or
wherein the information identifying a scheduled payment includes data representing a scheduled payment amount and a scheduled payment due date.

7. The method according to claim 5, further comprising reporting to a third party data receiving entity information representing the first entity's payment performance.

8. The method according to claim 7,
wherein the data receiving entity is a credit bureau or
wherein the reporting to a third party data receiving entity is conditioned on the reporting information being received from the second entity.

9. The method according to claim 5
wherein said authorizing of the payment comprises communicating a payment order message to a third party financial institution associated with effecting payment transactions between the first entity and the second entity or
further comprising receiving from a third party financial institution associated with effecting payment transactions between the first entity and the second entity payment confirmation information indicative of whether a payment to the seller was made based on a scheduled payment previously authorized by the system or
wherein the reporting information comprises information indicating approval of the scheduled payment by the second entity.

10. A method providing for automatic collection from a first entity on behalf of a second entity, the method being implemented by a computer system comprising at least one computer, at least one storage device, and programming that is stored on at least one computer readable medium and that when executed causes the at least one computer to implement the method comprising:
automatically collecting payments from the first entity to repay credit extended by the second entity according to a collection condition agreed upon by the first and second entities in the event that said first entity does not satisfy a payment obligation to the seller within a predetermined agreed term.

11. The method according to claim 10,
wherein automatically collecting payments from the first entity comprises invoking a series of debits from an account associated with said first entity, each debit being performed for an amount and at a time according to said collection condition or
further comprising notifying or invoking a collection agency in the event that said collection condition is not satisfied or

12. The method according to claim 10, further comprising reporting to a third party data receiving entity information representing the first entity's payment performance in the event that the collection condition is satisfied and/or in the event that the collection condition is not satisfied.

13. The method according to claim 12, wherein the data receiving entity is a credit bureau.

14. The method according to claim 5, further comprising providing a third party entity information representing the first entity's payment performance.

15. The method according to claim 14,
wherein the third party entity is not a credit bureau and neither shares nor sells credit data or
wherein the information representing the first entity's payment performance is provided to said third party entity in response to a request from said third party entity.

16. The method according to claim 5, further comprising storing information representing payment performance of the first entity.

17. The method according to claim 16,
further comprising performing a credit bureau function by providing at least a portion of the payment performance information concerning said first entity, and/or providing data generated or representing at least a portion of the payment performance information concerning said first entity, to another entity for the another entity's use in assessing first entity's creditworthiness or
wherein the another entity is considering extending credit to the first entity or
wherein the payment performance information concerning said first entity, or a at least a portion thereof, and/or data generated or representing at least a portion of the payment performance information, represents a credit score for said first entity.

18. The method according to claim 14,
wherein the operations of (i) receiving information representing a scheduled payment, (ii) authorizing a payment to the second entity, and (iii) providing a third party entity information representing the first entity's payment performance, are each carried out under the direction and control of a common entity or institution or
wherein the operations of (i) receiving information representing a scheduled payment, (ii) authorizing a payment to the second entity, and (iii) providing a third party entity information representing the first entity's payment performance, are each carried out under the direction and control of affiliated entities or institutions.

19. The method according to claim 17,
wherein the operations of (i) receiving information representing a scheduled payment, (ii) authorizing a payment to the second entity, (iii) storing information, and (iv) performing a credit bureau function by providing, are each carried out under the direction and control of a common entity or institution or
wherein the operations of (i) receiving information representing a scheduled payment, (ii) authorizing a payment to the second entity, (iii) storing information, and (iv) performing a credit bureau function by providing, are each carried out under the direction and control of affiliated entities or institutions.

20. The method according to claim 5, further comprising sharing the payment performance data for credit scoring, credit approval, credit monitoring or credit reporting purposes with other entities who do not act in any of a repository, sharing or selling function of credit data.

21. The method according to claim 20,
wherein the operations of (i) receiving information representing a scheduled payment, (ii) authorizing a payment to the second entity, and (iii) sharing the payment, are each carried out under the direction and control of a common entity or institution or
wherein the operations of (i) receiving information representing a scheduled payment, (ii) authorizing a payment to the second entity, and (iii) sharing the payment, are each carried out under the direction and control of affiliated entities or institutions.

22. The method according to claim 5, wherein the method comprises:
receiving information representing scheduled payments for each of a plurality of purchaser entities to be made respectively to each of a plurality of seller entities;
for each of the scheduled payments, conditioning authorization of the scheduled payments to the seller entity according to the scheduled payment in the event that reporting information is received from the seller entity;
storing information representing payment performance for each of the purchaser entities; and
performing a credit bureau function by selectively providing at least a portion of the payment performance information concerning one or more of the purchaser entitites, and/or providing data generated or representing at least a portion of the payment performance information concerning one or more of the purchaser entities, to one or more other entities for the one or more other entities' use in assessing one or more of the purchaser entities' credit-worthiness.

23. The method according to claim 5, wherein authorizing payment in the event that reporting information is received from said second entity is carried out or initiated by invoking payment in the event that the reporting information is received from said second entity.

24. The method according to claim 5, wherein authorizing payment is carried out or initiated by generating and/or transmitting an authorization message.

25. The method according to claim 24, wherein the authorization message is a payment order message.
